(19) United States
(12) Patent Application Publication
(10) Pub. No.: US 2010/0147267 A1
(43) Pub. Date: Jun. 17, 2010

(54) FUEL INJECTION SYSTEM FOR INTERNAL COMBUSTION ENGINE

(76) Inventors: Hiroaki Kato, Saitama (JP); Takao Iwasaki, Saitama (JP); Teruo Ohsawa, Saitama (JP); Hiroyuki Yano, Saitama (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/161,058

(22) PCT Filed: Jan. 19, 2007
(86) PCT No.: PCT/JP2007/050753

§ 371 Date: Jul. 16, 2008

(30) Foreign Application Priority Data
Jan. 20, 2006 (JP) 2006-011940
Feb. 24, 2006 (JP) 2006-047793
Feb. 24, 2006 (JP) 2006-047794

(51) Int. Cl. F02M 69/46; F02M 51/00; F04B 35/00

(52) U.S. Cl. 123/456; 123/476; 417/364

(57) ABSTRACT

To provide a fuel injection system that can efficiently supply high pressure fuel to fuel injectors of an internal combustion engine, whose design and manufacture are made easy by simplifying its mechanical configuration, and which has excellent maintainability during repair and detachment.

A fuel injection system for an internal combustion engine comprises: a cassette type pump that is attachable to and detachable from an internal combustion engine disposed with a cam and which pressurizes fuel to a high pressure and pressure-feeds the high pressure fuel by a plunger that reciprocally moves in accompaniment with rotation of the cam, and pressure-feeds the high pressure fuel; a common rail that accumulates the high pressure fuel that is pressure-fed from the cassette type pump and supplies the high pressure fuel with respect to plural fuel injectors; a pressure regulator that regulates the pressure inside the common rail; and pressure control means that controls the pressure regulator on the basis of the pressure value inside the common rail.

### TECHNICAL FIELD

The present invention relates to a fuel injection system for an internal combustion engine and to a fuel injection system for an internal combustion engine that is used mainly in industrial engines of agricultural machinery and construction machinery.

### BACKGROUND ART

Conventionally, in industrial engines installed in agricultural machinery and construction machinery, a fuel injection system disposed with a cassette type pump and fuel injection nozzles has been used as a fuel injection system that injects fuel from fuel injectors of a diesel engine. This fuel injection system pressure-feeds fuel that has been pressurized to a high pressure by the cassette type pump that is attached to the engine and injects the fuel that has been pressure-fed into cylinders of the diesel engine from the fuel injection nozzles.

In this fuel injection system, valves of a check valve structure that are opened when the pressure of the fuel exceeds a predetermined value and closed when the pressure of the fuel falls below a predetermined value are used as the fuel injection nozzles, and the injection amount and the injection timing of the fuel are controlled mainly by the cassette type pump.

As such a cassette type pump, as shown in FIG. 12, there is a pump 300 that is attachable to and detachable from a diesel engine disposed with a cam, and the pump 300 is disposed with a circular cylinder-shaped barrel 303 that is held inside a housing 301, a plunger 305 that is disposed such that it may freely reciprocally move inside the barrel 303 and is for pressurizing fuel in response to rotation of the cam, a spring 307 that energizes the plunger 305 in an opposite direction of a direction in which the plunger 305 pressurizes the fuel, and a discharge valve 309 for discharging the fuel that has been pressurized by the plunger 305 (for example, see Patent Documents 1 and 2).

In this cassette type pump, fuel is fed to a fuel pressurization chamber via a fuel path disposed in the housing in a state where the plunger is lowered, the plunger rises in accompaniment with the rotation of the cam disposed in the engine, a suction port is closed, and the fuel inside the fuel pressurization chamber is pressurized to a high pressure. Then, the fuel is pressure-fed to corresponding fuel injection nozzles via the discharge valve when the fuel exceeds a predetermined pressure.

In this cassette type pump, control of the flow rate of the fuel that is pressure-fed is performed using a lead comprising a groove that is formed in a diagonal direction with respect to an axial direction disposed in the plunger and a rack mechanism for causing the plunger to rotate about an axis. Specifically, because the lead is disposed in the plunger, when the plunger rises to a predetermined position, the fuel pressurization chamber and the fuel path become communicated, the fuel inside the fuel pressurization chamber is spilled into the fuel path via the lead, and the flow rate of the fuel that is pressure-fed is regulated. Further, because the lead is disposed in a diagonal direction with respect to the axial direction of the plunger, the capacity inside the fuel pressurization chamber at a point in time when the fuel inside the fuel pressurization chamber is returned is regulated by the rotational position of the plunger, and the flow rate of the fuel that is discharged is controlled to a desired value. The rotational position of the plunger is determined by controlling the rack mechanism by a governor mechanism or the like that is connected to the engine.

Further, in this cassette type pump, control of the injection timing of the fuel is performed by, for example, disposing a timer, causing the cam shaft to advance, and adjusting the timing of the rise of the plunger.

In this manner, the fuel injection system in a conventional industrial engine controls the injection amount and the injection timing of the fuel by the mechanical configuration of the pump, and has a configuration that is compact and mechanical in comparison to other fuel injection systems used for automobiles and large vehicles.

On the other hand, as fuel injection systems of engines used for automobiles and large vehicles, various types of pressure accumulating fuel injection systems (sometimes called “common rail system(s)” below) using a pressure accumulator (common rail) have been proposed. This pressure accumulating fuel injection system is, as shown in FIG. 13, disposed with a fuel supply pump 410 that is disposed with a pump body 411, a feed pump 407 and a regulating valve 419, with a cam 415 being disposed in the pump 410 itself, a pressure accumulator 420 that accumulates high pressure fuel that is pressure-fed from the pump 410 and pressure-feeds the high pressure fuel with respect to plural injectors, and injectors (not shown) that inject, with respect to cylinders of an internal combustion engine, the fuel that is pressure-fed.

In this pressure accumulating fuel injection system 400, control of the injection amount of the fuel is performed by electromagnetically controlling the opening degree of the regulating valve of the fuel supply pump 410 and the injectors. Further, control of the injection timing of the fuel is performed by electromagnetically controlling the timing when injection holes of the injectors are opened.

This pressure accumulating fuel injection system can raise the pressure of the fuel to a higher pressure and can precisely control the injection amount and the injection timing of the fuel, so it can easily realize control of the operating state of the engine and purification of exhaust gas that is discharged.

Patent Document 1: JP-B-7-117017 (FIG. 6)

Patent Document 2: JP-A-11-343944 (FIG. 1)

### DISCLOSURE OF THE INVENTION

### Problem that the Invention is to Solve

However, the fuel injection system that uses a cassette type pump described in Patent Document 1 performs control of the injection amount and the injection timing by the mechanical configuration of the cassette type pump, it is necessary for the structures of the respective members to become complex in order to precisely perform control, and high-precision design of the pump and the cam has been required.

Further, in order to respond to the request for even higher pressurization of fuel in order to accommodate tightening of emissions restrictions in recent years, it has been necessary to enlarge the diameter and the stroke amount of the plunger or to improve the shape of the cam mountain of the engine. Moreover, in conventional cassette type pumps, it has been necessary to take measures to prevent wear and damage resulting from the high pressure fuel being spilled, and it has been necessary to make the structures of the members even more complex in order to respond to even higher pressurization. On the other hand, when the configurations of those members are made complex, there are also instances where their strength drops, their durability drops, and a limit is seen on high pressurization.

On the other hand, the pressure accumulating fuel injection system shown in FIG. 13 is capable of more precise control of the injection timing and the injection amount by the regulating valve 419 and the injectors, but the pump that is used is a relatively large pump disposed with the feed pump 407, the pump body 411 and the regulating valve 419. Consequently, there has been the problem that it is difficult to employ this pressure accumulating fuel injection system in the field of industrial engines because its layout and design during installation are difficult in comparison to a cassette type pump, and maintenance such as repair, replacement and detachment takes effort.

Moreover, in the case of the pressure accumulating fuel injection system shown in FIG. 13, the pump 410 is uniquely disposed with the cam 415, and it is necessary to circulate engine fuel or to separately introduce lubricating oil as lubricating oil that suffuses the sliding surfaces between the plunger and the plunger barrel and the sliding surfaces between the cam and the tappet Consequently, when engine fuel is used, high lubricity and cleanliness are demanded of that engine fuel, and when the lubricity and cleanliness of the fuel do not satisfy a desired standard, there has been the potential for the fuel to lower the endurance reliability of the pump. On the other hand, when lubricating oil is separately introduced, management of the lubricating oil becomes necessary in addition the engine fuel and the engine oil, and it is difficult to say that this is suitable for the field of industrial engines where a configuration that is as simple as possible and a high degree of durability are desired.

Thus, as a result of their extensive investigations, the inventors of the present invention have discovered that this problem can be solved by employing a pressure accumulating fuel injection system in a fuel injection system that includes a cassette type pump that is used mainly in industrial engines and disposing a pressure regulator that regulates the pressure inside the common rail.

That is, it is an object of the present invention to provide a fuel injection system that can abbreviate the mechanical structure of a cassette type pump, whose design and manufacture are easy, has excellent durability, has excellent maintainability during repair, replacement and detachment, and can stably supply predetermined high pressure fuel with respect to fuel injectors of an internal combustion engine.

### Means for Solving the Problem

According to the present invention, there is provided a fuel injection system for an internal combustion engine comprising: a cassette type pump that is attachable to and detachable from an internal combustion engine disposed with a cam and which pressurizes fuel to a high pressure and pressure-feeds the high pressure fuel by a plunger that reciprocally moves in accompaniment with rotation of the cam; a common rail that accumulates the high pressure fuel that is pressure-fed from the cassette type pump and supplies the high pressure fuel with respect to plural fuel injectors; a pressure regulator that regulates the pressure inside the common rail; and pressure control means that controls the pressure regulator on the basis of the pressure value inside the common rail, and the aforementioned problem can be solved.

Further, in configuring the fuel injection system of an internal combustion engine of the present invention, it is preferred that the fuel injectors are electromagnetic valves and that the fuel injection system further comprises injection control means that controls the fuel injection amount or the fuel injection timing of the electromagnetic valves.

Further, in configuring the fuel injection system of an internal combustion engine of the present invention, it is preferred that the fuel injection system is disposed with a plurality of the cassette type pump.

Further, in configuring the fuel injection system of an internal combustion engine of the present invention, it is preferred that the fuel injection system further comprises an orifice in a fuel path on an upstream side of the cassette type pump.

Further, in configuring the fuel injection system of an internal combustion engine of the present invention, it is preferred that the cassette type pump includes a housing that includes a cylindrical space whose both ends are open, a circular cylinder-shaped barrel that is inserted into the cylindrical space in the housing, a plunger that is held such that the plunger may freely reciprocally move inside the barrel and is for pressurizing the fuel in response to the rotation of the cam, a spring that energizes the plunger in an opposite direction of a direction in which the plunger pressurizes the fuel, and a discharge valve for discharging the fuel that has been pressurized by the plunger, and that the outer peripheral surface of the barrel is disposed with a flange portion, and the flange portion is nipped by and held between the housing and a fixing plate, whereby the barrel is fixed to the housing.

Further, in configuring the fuel injection system of an internal combustion engine of the present invention, it is preferred that the outer shape, of a section cut in a direction intersecting an axial direction of the cylindrical space, of a body portion of the housing inserted into the internal combustion engine is substantially perfectly circular.

Further, in configuring the fuel injection system of an internal combustion engine of the present invention, it is preferred that the flange portion has a circular shape that is concentric with the outer periphery of the barrel.

Further, in configuring the fuel injection system of an internal combustion engine of the present invention, it is preferred that the planar shape of the fixing plate is rectangular or elliptical.

Further, in configuring the fuel injection system of an internal combustion engine of the present invention, it is preferred that the cassette type pump is disposed with a plurality of the barrel and the plunger.

Further, in configuring the fuel injection system of an internal combustion engine of the present invention, it is preferred that the fuel injection system is a fuel injection system that is used in any of construction machinery, agricultural machinery, small marine vessels and electrical generators.

### EFFECTS OF THE INVENTION

According to the fuel injection system of the present invention, by employing, in a fuel injection system for an internal combustion engine, a common rail disposed with a cassette type pump of a predetermined structure whose mechanical configuration is simplified, a common rail and a predetermined pressure regulator, the fuel injection system can be made into a fuel injection system where the design and manufacture of the cassette type pump are made easy and the entire system is simplified in comparison to a conventional common rail system. Consequently, the mechanical strength and durability of the fuel injection system can be improved even when the fuel injection system supplies higher pressure fuel in the field of industrial engines.

Further, by disposing the common rail and the pressure regulator, control of the fuel flow rate and pressure by the cassette type pump becomes unnecessary, and control of the injection amount and the injection pressure can be performed precisely. Consequently, the start-up performance of the fuel injection system when it is cold can be improved, and noise during operation of the internal combustion engine can be reduced.

Further, by employing a cassette type pump as the pump in the common rail system, maintainability during repair, replacement and detachment can be improved. Further, when the pump is a cassette type pump, effort to synchronize the pump with the gears of the internal combustion engine when the pump is attached can be omitted because the internal combustion engine is disposed with a cam for causing the plunger of the pump to reciprocally move, the work of attachment can be made more efficient, and the operating stability of the pump can be improved. Moreover, because the pump is a cassette type pump, the number of pumps and the number of plungers can be freely selected in accordance with the purpose of use of the internal combustion engine, and regulation of the flow rate of the fuel that is supplied to the common rail becomes easy.

Moreover, by employing a cassette type pump as the pump in the common rail system, engine oil introduced to the inside of the internal combustion engine can be utilized as lubricating oil that suffuses the contact surfaces between the cam and the plunger, the cam and the spring seat, the cam and the tappet, and the sliding surface of the tappet, so lubricity can be ensured regardless of the cleanliness of the engine fuel that is used. Additionally, because the lubricity of the respective parts is improved, the pump can be made into a pump that has excellent durability even when the pump supplies fuel of a pressure that is higher than has conventionally been the case.

### BRIEF DESCRIPTION OF THE DRAWINGS

FIG. 1 A diagram provided for describing the configuration of a fuel injection system pertaining to an embodiment of the present invention.

FIG. 2 Cross-sectional diagrams of a cassette type pump of the embodiment.

FIG. 3 A diagram, provided for describing the shape of a housing of a conventional cassette type pump.

FIG. 4 Diagrams provided for describing stress acting on cassette type pumps.

FIG. 5 Diagrams provided for describing the cross-sectional shape of a housing of the cassette type pump of the embodiment.

FIG. 6 Cross-sectional diagrams of the cassette type pump where part of the housing has a slender shape.

FIG. 7 Diagrams provided for describing the shape of a flange portion of the cassette type pump of the embodiment.

FIG. 8 Diagrams for describing a region of a plunger where it is difficult for lubricating oil to move around.

FIG. 9 A diagram showing a fuel injection system disposed with plural cassette type pumps.

FIG. 10 An example of the configuration of a fuel injection system where an overflow valve is disposed in a fuel reflux path from a cassette type pump.

FIG. 11 An example of the configuration of a fuel injection system where a fuel reflux path from a cassette type pump is caused to merge with a fuel reflux path from a pressure regulating valve.

FIG. 12 A diagram provided for describing the configuration of a conventional cassette type pump.

FIG. 13 A diagram provided for describing the configuration of a conventional common rail system.

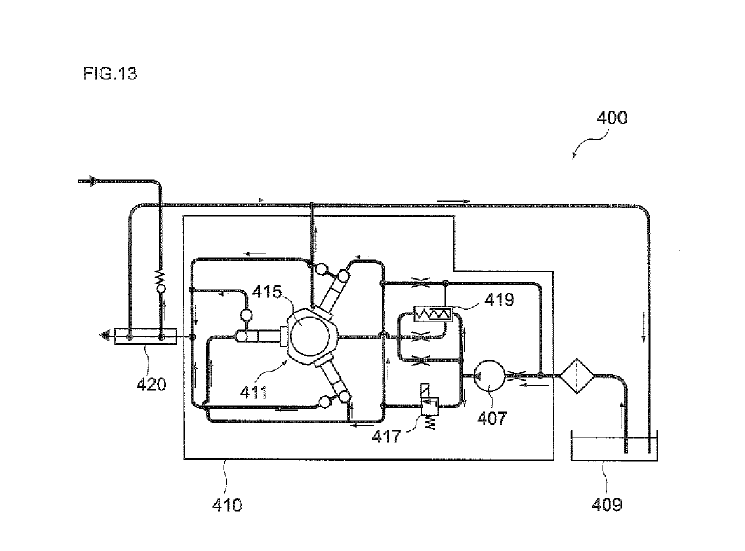

### BEST MODE FOR IMPLEMENTING THE INVENTION

Below, an embodiment relating to a fuel injection system for an internal combustion engine of the present invention will be specifically described with reference to the drawings. However, this embodiment represents one aspect of the invention, is not intended to limit this invention, and can be arbitrarily altered within the scope of the present invention.

The embodiment of the present invention is a fuel injection system for an internal combustion engine (sometimes simply called a “fuel injection system” below) comprising: a cassette type pump (sometimes simply called a “pump” below) that is attachable to and detachable from an internal combustion engine disposed with a cam and which pressurizes fuel to a high pressure and pressure-feeds the high pressure fuel by a plunger that reciprocally moves in accompaniment with rotation of the cam; a common rail that accumulates the high pressure fuel that is pressure-fed from the cassette type pump and supplies the high pressure fuel with respect to plural fuel injectors; a pressure regulator that regulates the pressure inside the common rail; and pressure control means that controls the pressure regulator on the basis of the pressure value inside the common rail.

Below, this fuel injection system for an internal combustion engine will be divided into its respective parts and specifically described.

### 1. Overall Configuration of Fuel Injection System

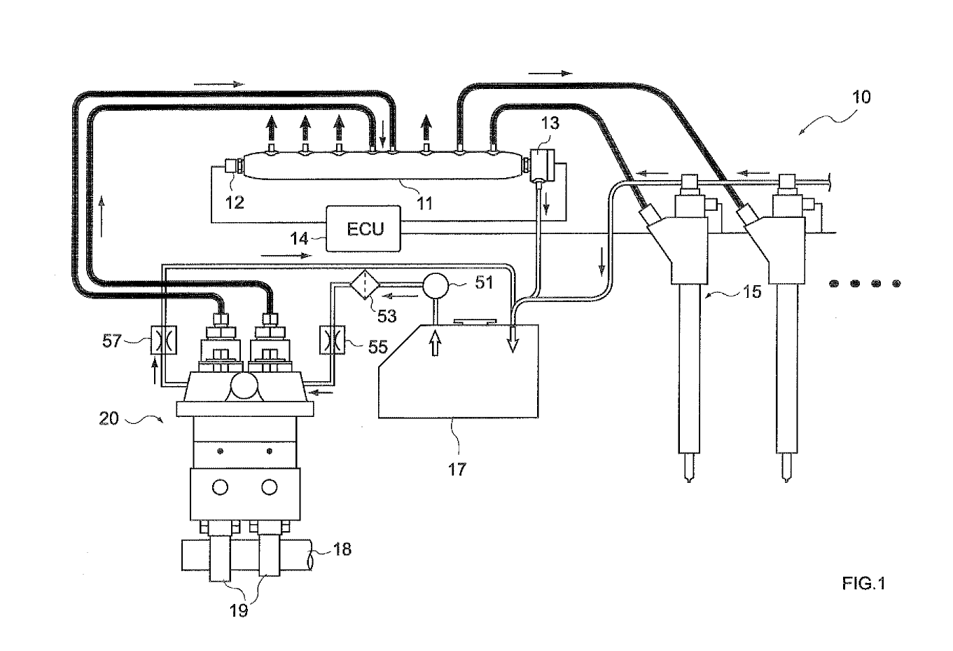

First, the overall configuration of a fuel injection system 10 of the present embodiment will be described with reference to FIG. 1. This fuel injection system 10 is a system for supplying fuel to fuel injectors (sometimes called “injectors”) 15 disposed in an internal combustion engine such as a diesel engine and causing the fuel injectors 15 to inject the fuel, and the fuel injection system 10 basically includes: a fuel tank 17; a cassette type pump (sometimes simply called a “pump” below) 20 that is attachable to and detachable from an internal combustion engine (not shown) disposed with cams 19; a common rail 11 serving as a pressure accumulator; a pressure regulator 13 for regulating the pressure inside the common rail 11; control means 14 that controls the pressure regulator; and injectors 15 serving as fuel injectors that inject, into cylinders of the internal combustion engine, high pressure fuel supplied from the common rail 11.

Further, the fuel tank 17 and the cassette type pump 20, the cassette type pump 20 and the common rail 11, and the common rail 11 and the injectors 15 are respectively interconnected by fuel supply paths. Further, fuel reflux paths for refluxing excess fuel to the fuel tank 17 are connected to the cassette type pump 20, the pressure control valve 13 disposed in the common rail 11, and the injectors 15. In FIG. 1, the paths on the low pressure side are shown in white and the paths on the high pressure side are shown in black.

Further, the fuel injection system pertaining to the present invention is used mainly in construction machinery, agricultural machinery, small marine vessels and electrical generators, and moreover in small industrial engines used in order to drive on-board refrigerator compressors. This is because it is necessary for engines used in the aforementioned industrial fields to have a high degree of endurance reliability, and expensive measures end up becoming necessary in the pump in order to satisfy that requirement with a fuel lubrication system. That is, by employing a cassette type pump attached to an internal combustion engine as in the present invention, engine oil whose lubricity is high can be used as lubricating oil, and the endurance reliability of the pump can be improved without an increase in cost.

### 2. Internal Combustion Engine

The unillustrated internal combustion engine is disposed with a cam shaft 18 that is connected to a crankshaft via a gear or the like. Further, the cams 19, which are disposed in a number corresponding to the total number of plungers in the cassette type pump 20 attached to the internal combustion engine, are connected to the cam shaft 18. Further, although they are not illustrated, one or plural openings that become attachment places of the cassette type pump 20 are disposed in a housing of the internal combustion engine in correspondence to the positions of the cams 19. For example, as mentioned later, when the outer shape of the housing of the cassette type pump is perfectly circular, the opening is also substantially perfectly circular.

Further, because the fuel injection system 10 of the present invention has a configuration where the cams 19 are disposed in the internal combustion engine and not in the pump 20, the selection range of the base diameter of the cams broadens in comparison to a conventional cam disposed in the pump, and the cam design can be done easily. Further, because the base diameter of the cams can be made large, stress received when driving the pump can be alleviated.

Moreover, in the fuel injection system of the present invention, as mentioned later, just the function of raising the pressure of the fuel to a high pressure and pressure-feeding the high pressure fuel is demanded of the cassette type pump, so the complex design of a cam mountain such as has been employed in a conventional cassette type pump can be abbreviated. Consequently, even when the cams are rotated at a high speed in order to increase the fuel flow rate, the durability of the cams is improved and their reliability can be improved. Further, effort to synchronize the cams with gears of the internal combustion engine when the pump is attached can be omitted because the cams are disposed in the internal combustion engine, the work of attachment can be made more efficient, and the operating stability of the pump can be improved.

### 3. Cassette Type Pump

### (1) Basic Configuration

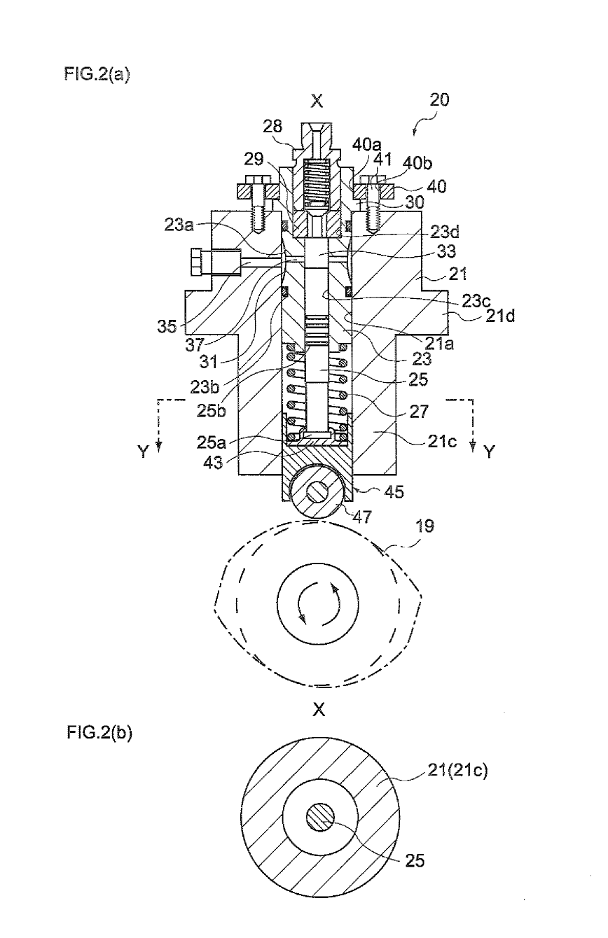

The cassette type pump 20 is a part for raising the pressure of the fuel to a high pressure and pressure-feeding the high pressure fuel to the common rail 11. FIG. 2 shows an example of the configuration of the cassette type pump 20 used in the fuel injection system 10 of the present embodiment.

FIG. 2 is a cross-sectional diagram of an XX cross section of the cassette type pump 20 shown in FIG. 1 as seen from the direction of the arrows. The cassette type pump 20 is disposed with a housing 21 that includes a cylindrical space 21a whose both ends are open, a substantially circular cylinder-shaped barrel 23 that is inserted into the cylindrical space 21a in the housing 21, a plunger 25 that is held by the barrel 23 such that the plunger may freely reciprocally move and is for pressurizing the fuel in response to the rotation of the cams 19 disposed in the internal combustion engine, a spring 27 that energizes the plunger 25 in an opposite direction of a direction in which the plunger 25 pressurizes the fuel, and a discharge valve 29 for discharging the fuel that has been pressurized by the plunger 25.

The discharge valve 29 is a so-called check valve type of valve that is opened when the high pressure fuel inside a fuel pressurization chamber 33 that is pressurized by the plunger 25 exceeds a predetermined pressure value and is closed when the pressure inside the fuel pressurization chamber 33 falls below a predetermined value, and the discharge valve 29 is fixed as a result of being screwed by a holder 28 from above.

In this cassette type pump 20, in a state where the plunger 25 is pushed down by the energizing force of the spring 27, fuel that has been pressure-fed from the fuel tank flows, via a fuel passage 35 disposed in the housing 21, into a pressure introduction chamber 31 that is formed by the cylindrical space 21a in the housing 21 and a groove portion 23a in the outer peripheral surface of the barrel 23, and flows into the fuel pressurization chamber 33 via a fuel passage 37 that interconnects the pressure introduction chamber 31 and the fuel pressurization chamber 33 disposed in the barrel 23.

Additionally, when the plunger 25 is pushed up in accompaniment with the rotation of the cams 19 disposed in the internal combustion engine, the fuel passage 37 of the barrel 23 that had been exposed to the fuel pressurization chamber 33 becomes closed by the plunger 25, and the fuel inside the fuel pressurization chamber 33 is pressurized to a high pressure. Thereafter, when the pressure of the fuel inside the fuel pressurization chamber 33 exceeds a predetermined threshold value, the discharge valve 29 is opened and the fuel is pressure-fed to the common rail.

In this manner, just the function of raising the pressure of the fuel to a high pressure and continuously pressure-feeding the high pressure fuel is demanded of the cassette type pump used in the fuel injection system of the present invention, and it becomes unnecessary to dispose a lead in the plunger and dispose a rack and governor mechanism for controlling the rotational position of the plunger in order to perform flow rate control and pressure regulation as in a conventional cassette type pump. Consequently, it becomes unnecessary to implement high pressure fuel spill measures and to precisely control the stroke amount of the plunger and the injection timing. Thus, the mechanical configuration of the respective members that configure the pump can be abbreviated and remarkably simplified, so mechanical strength is improved, and wear and damage can be reduced even when the pump supplies higher pressure fuel. Further, because the configuration of the pump can be remarkably simplified, the parts that configure the pump can be universally used without limit to the type and specification of the internal combustion engine, and economical design and production become possible.

Further, when the pump is a cassette type pump, it suffices for the installation space to be small in comparison to an independent pump such as used in a conventional common rail system, so the layout and design of the pump can be made relatively easy. Further, because the pump can be easily detached, maintenance work such as repair, replacement and detachment of the pump can be performed efficiently.

Moreover, by employing a cassette type pump as the pump of the common rail system, engine oil introduced to the inside of the internal combustion engine can be utilized as lubricating oil that suffuses the contact surfaces between the cam and the plunger, the cam and the spring seat, the cam and the tappet, and the sliding surface of the tappet. Consequently, management and maintenance of the lubricating oil becomes easy in comparison to an independent pump used in a conventional common rail system. Further, although there are also fuel lubrication systems that use engine fuel as lubricating oil, by using engine oil as lubricating oil, it becomes unnecessary to take into consideration the lubricity of the engine fuel. Additionally, the lubricity of the respective parts is improved, so the pump can be made into a pump that has excellent durability and whose reliability is high even when the pump supplies fuel of a pressure that is higher than has conventionally been the case.

### (2) Housing

The outer shape of the housing 21 of the cassette type pump shown in FIG. 2 is not particularly limited, but by unifying the outer shape of the housing 21 to a predetermined shape even when the diameters of the plungers are different and allowing the shape of the opening that is disposed in the internal combustion engine and serves as the attachment place of the pump 20 to correspond to the outer shape of the housing 21, the advantage that pumps whose specifications are different can be freely selected and used in different types of internal combustion engines is obtained. For example, the housing of the cassette type pump shown in FIG. 2 includes a body portion 21c that is inserted into the internal combustion engine and a flange portion 21d that is attached and fixed to the internal combustion engine, and the cylindrical space 21a, whose both ends are open and into which the barrel 23 is inserted, is disposed inside the housing. It is preferable for the cylindrical space 21a to not be disposed with a step or a groove in its inner peripheral surface in order to make workability when forming the cylindrical space 21a easier.

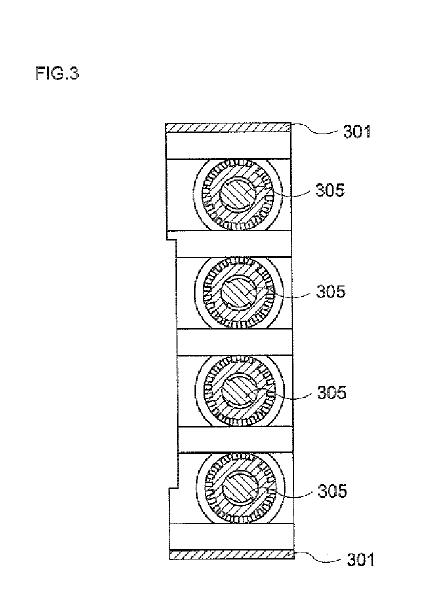

Here, the cassette type pump is used after being inserted into the opening disposed in the housing of the internal combustion engine, and the precision of clearance when the cassette type pump is fitted together with the opening in the housing of the internal combustion engine is required, but as shown in FIG. 3, when the cassette type pump has the housing 301 that has a rectangular or oblong cross sectional shape, there is the problem that workability is poor, working efficiency is low, and the dimensional precision of the outer shape is low. As a result, when this cassette type pump housing is employed in the fuel injection system of the present invention and the cam is rotated at a high speed in order to pressure-feed a large amount of high pressure fuel, there is the potential for stress to combine with repulsive stress from the plunger and concentrate in part of the housing outer shape and for cracks and abnormal wear to arise in the housing of the cassette type pump or the housing of the internal combustion engine. For that reason, it is necessary to raise the precision of the clearance between the housing of the cassette type pump and the housing of the internal combustion engine and disperse stress.

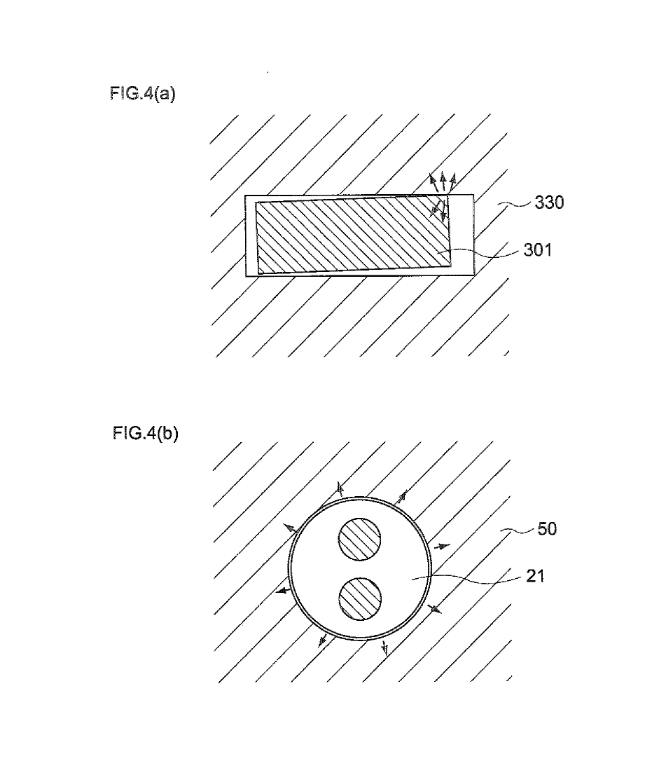

More specifically, when the pump is driven, stress acts with respect to the cassette type pump in a direction intersecting the axial direction of the plunger because of the upward force of the plunger resulting from the cam and the repulsive force of the plunger received from the fuel that has been pressurized. At this time, when the outer shape of the housing of the cassette type pump is oblong as shown in FIG. 3, then as shown in FIG. 4(a), there is the potential for stress to end up concentrating in part of a housing 401 and for the housing 401 of the pump or a housing 430 of the internal combustion engine to sustain damage.

Thus, in the cassette type pump used in the fuel injection system of the present embodiment, as shown in FIG. 2(b), it is preferable for the outer shape of a section where the body portion 21c of the housing is cut in a direction intersecting the axial direction of the cylindrical space 21a to be substantially perfectly circular. Thus, workability when working and molding the housing becomes easy and working precision can be improved, so the precision of the clearance when the housing is inserted into the substantially perfectly circular open portion disposed in the housing of the internal combustion engine can be remarkably improved. As a result, even when the cassette type pump is employed in a common rail system and the cam is rotated at a high speed to cause the plunger to reciprocally move at a high speed in order to pressure-feed high pressure fuel, stress can be dispersed, a situation where stress acts partially on part of the housing can be prevented, and there become fewer instances where the housing of the pump and the housing of the internal combustion engine become worn and cracks arise. By forming the outer shape of the housing of the cassette type pump in this manner, this can contribute to the realization of a fuel injection system that has excellent long-term reliability and is capable of stable injection of high pressure fuel.

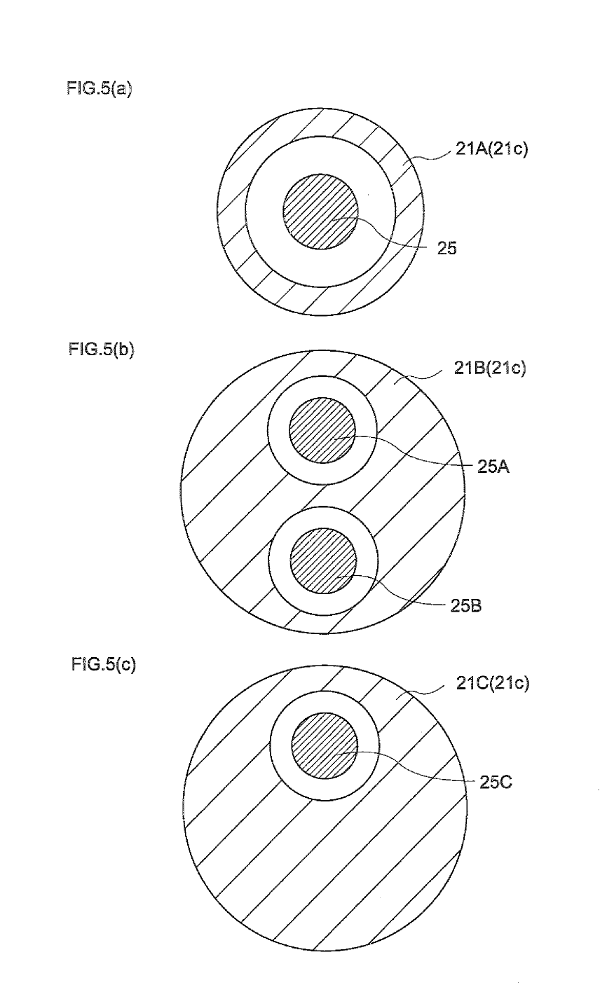

FIGS. 5(a) to (c) show examples of housings that include a perfectly circular body portion. FIGS. 5(a) to (c) show states of housings 21A, 21B and 210 and plungers 25, 25A, 25B and 25C in sections (sections that are the same as FIG. 2(b)) where the cassette type pump is cut in a direction intersecting the axial direction of the cylindrical space in which the plunger 25 slides and is held. FIGS. 5(a) and (c) are housings 21A and 21C that respectively house one plunger 25 and 250, and FIG. 5(b) is a housing 21B that houses two plungers 25A and 253. In particular, FIGS. 5(b) and (c) are configural examples where the open portion of the internal combustion engine to which the cassette type pump is attached is shared and where just the number of cylinders in the cassette type pump is changed.

When the housing is worked into a perfectly circular shape in this manner, the working can be performed by end milling or machining. By working the housing with such a method, the outer shape of the housing can be precisely and efficiently made into a perfect circle.

It will be noted that, in the present invention, when the body portion of the housing is made into a substantially perfectly circular shape, it suffices for at least just the portion of the body portion that presses against the engine to have a perfectly circular shape.

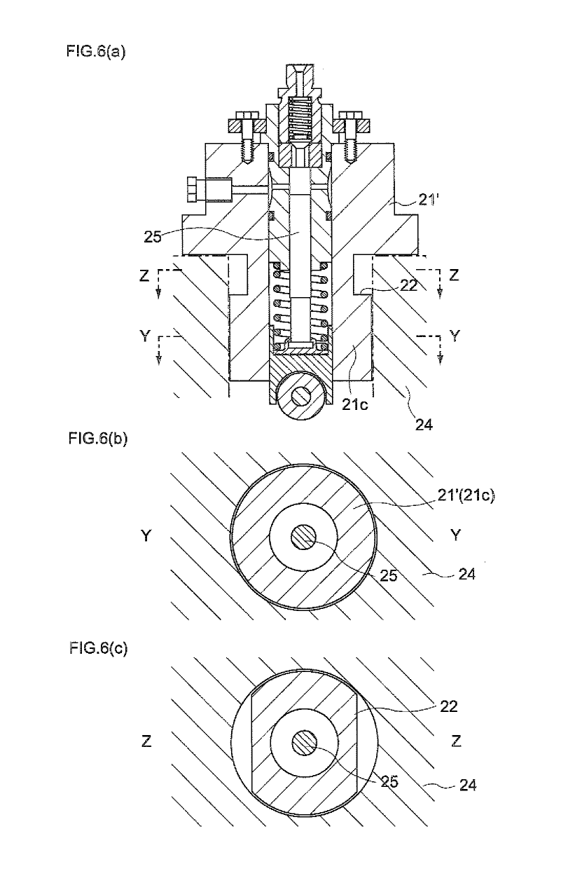

For example, as shown in FIG. 6(a), in the case of a housing 21′ where part (22 in the drawing) of the body portion 21c has a slender shape, then as shown in FIG. 6(b), at least the outer shape of the place that contacts a housing 24 of the engine other than the slender-shaped portion 22 can be given a substantially perfect circle shape and, as shown in FIG. 6(c), the outer shape of the slender-shaped portion 22 can be given a non-perfectly circular shape.

It will be noted that FIG. 6(b) is a cross-sectional diagram where the YY cross section in FIG. 6(a) is seen in the direction of the arrows, and FIG. 6(c) is a cross-sectional diagram where the ZZ cross section in FIG. 6(a) is seen in the direction of the arrows.

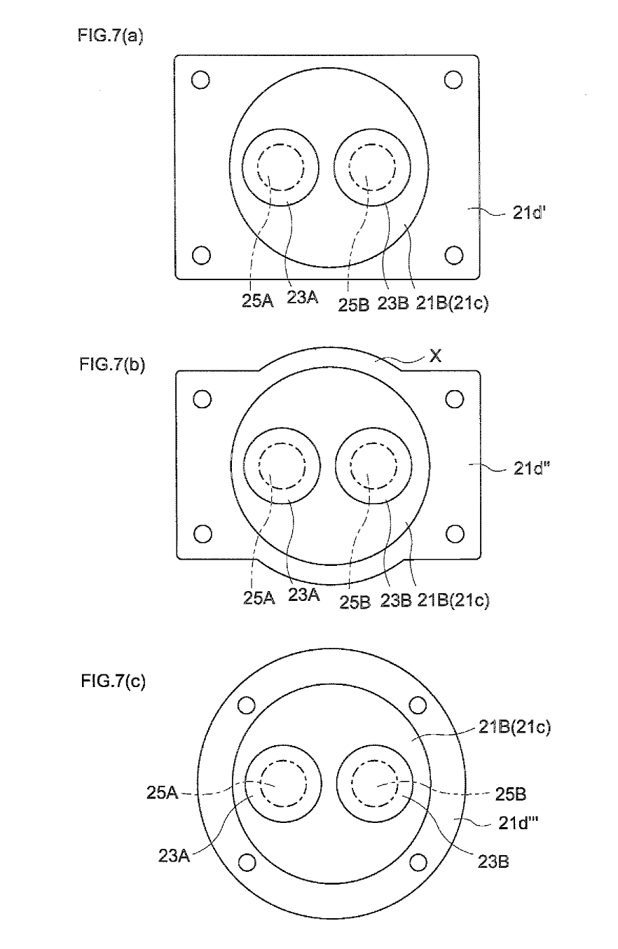

Further, the flange portion 21d that becomes the portion attached to the internal combustion engine can be given a planar shape such as shown in FIGS. 7(a) to (c). FIGS. 7(a) to (c) are diagrams where the cassette type pump is seen from below, and members other than the housing, the barrel, the plunger and the flange portion are omitted.

That is, FIG. 7(a) is a flange portion 21d′ that has a substantially rectangular shape, FIG. 7(b) is a flange portion 21d″ that is oblong overall and on which a convex portion X is formed in correspondence to the shape of the body portion 21c, and FIG. 7(c) is a flange portion 21d′″ whose overall shape is circular. Among these, by making the flange portion into a circular flange portion such as shown in FIG. 7(c), the size of the flange portion can be made smaller, so the cassette type pump and the fuel injection system can be made compact.

On the other hand, when the flange portion is the flange portion 21d′ shown in FIG. 7(a), the distance from the center of the pump to the end portions of the flange portion can be made shorter, so interference with the engine can be avoided relatively easily. Further, taking into consideration being able to easily identify the attachment direction when attaching the pump to the engine, and that there are many pumps where other parts such as a generator, a fuel filter and an air filter are circularly seen, there is also the advantage that they can be differentiated at a glance.

It will be noted that the plural holes disposed in the flange portions 21d′ to 21d′″ are screw holes for fixing the cassette type pump to the internal combustion engine.

### (3) Barrel

The barrel 23 shown in FIG. 2 is a substantially circular cylinder-shaped member that has an outer shape conforming to the cylindrical space 21a in the housing 21. The outer peripheral surface of the barrel 23 is disposed with a first groove portion 23a that forms the pressure introduction chamber together with the inner peripheral surface of the housing 21 and plural seal ring groove portions 23b for preventing fuel leakage from between the outer peripheral surface of the barrel 23 and the inner peripheral surface of the housing 21. Further, the inner portion of the barrel 23 includes a small diameter space 23c that is an element into which the plunger 25 is inserted and which forms the fuel pressurization chamber 33 and a large diameter space 23d in which the discharge valve 29 is disposed. Additionally, the plunger 25 is inserted from below and slidably held in the small diameter space 23c, and the discharge valve 29 is inserted from above into the large diameter space 23d and fixed by screwing the holder from above.

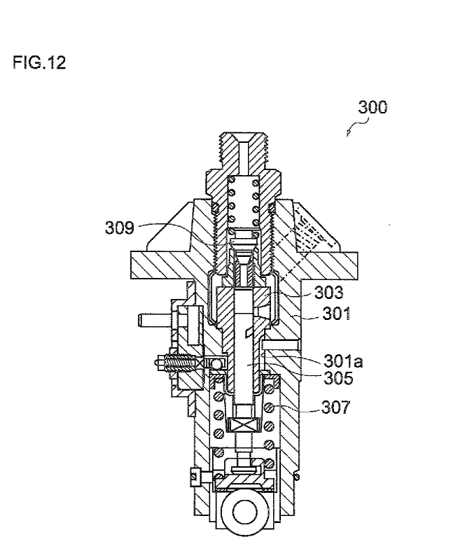

Here, the conventional cassette type pump shown in FIG. 12 has a configuration where the barrel 303 that slidably holds the plunger 305 inside is nipped by and held between a holder 306 and the housing 301 from the vertical direction at a place that is close to the small diameter space where the plunger 305 slides, so there is the potential for the barrel 303 to receive stress that acts when the discharge valve 309 is fixed and to become deformed. When deformation of the barrel 303 occurs, the small diameter space where the plunger 305 slides becomes deformed and inhibits the reciprocal motion of the plunger 305.

That is, a clearance is disposed between the barrel and the plunger in order to control wear at the sliding surfaces thereof, and the clearance is filled with lubricating oil, but there are cases where the pressure of the fuel that is pressure-fed is a relatively low pressure as in a conventional small industrial engine, and in the fuel injection system of the present invention where a pressure value equal to or greater than 1.5 times in comparison to what has conventionally been the case is demanded, when the clearance between the plunger and the barrel is narrowed by deformation of the small diameter space of the barrel, the potential for an oil film formed by fuel oil serving as lubricating oil to become scarce and cause burning becomes higher. In particular, in the fuel injection system of the present invention, it is conceivable for stress generated in the pump to become larger, for the drive speed of the pump to become faster, and for the potential for damage to the barrel and the plunger to become higher.

Thus, the cassette type pump used in the fuel injection system of the present embodiment is, as shown in FIG. 2, disposed with a flange portion 30 on the outer peripheral surface of the barrel 23, and the flange portion 30 is nipped by and held between the housing 21 and a fixing plate 40, whereby the barrel 23 is fixed to the housing 21. Consequently, the upper side and the lower side of the barrel 23 are opened other than when stress acts on just the flange portion 30, so stress from the fixing plate 40 and stress when fixing the discharge valve 29 can be prevented from extending to the small diameter space 23c where the plunger 25 reciprocally moves. Thus, the small diameter space 23c does not become deformed and the reciprocal motion of the plunger 25 is not inhibited, so the durability of the pump can be improved even when the cassette type pump is employed in a common rail system and pressure-feeds a large amount of high pressure fuel in accompaniment with the high speed rotation of the cams 19. For that reason, in the fuel injection system of the present invention, stress acting on the barrel is reduced as much as possible and deformation of the small diameter space is prevented.

Further, it is preferable for the flange portion 30 to be the substantially perfectly circular flange portion 30 that has a circular shape that is concentric with the outer periphery of the barrel 23. When the flange portion has this shape, manufacturing and working can be made remarkably easy. That is, when the flange portion has an elliptical shape or a polygonal shape, working when manufacturing the flange portion takes effort, but because the outer periphery of the flange portion is substantially perfectly circular, workability during manufacture can be remarkably improved and working precision can be improved.

### (4) Fixing Plate

The fixing plate 40 shown in FIG. 2 is a member for fixing the barrel 23 with respect to the housing 21 as a result of the fixing plate 40 being screwed with respect to the housing 21 such that the fixing plate 40 pins the flange portion 30 formed on the outer peripheral surface of the barrel 23 against the housing 21. The fixing plate includes an open portion 40a that corresponds to the outer peripheral shape of the barrel 23 and whose diameter is smaller than the diameter of the flange portion 30 disposed on the barrel 23 and plural fixing holes 40b into which screws 41 are inserted.

Further, although the planar shape of the fixing plate is not particularly limited, the fixing plate can have a vertically long elliptical or rectangular planar shape and can have a configuration where the open portion is disposed in the center portion of the fixing plate and where the fixing holes are disposed on both end portions of the fixing plate. Thus, even when a plurality of the plungers 25 are arranged in parallel, the distance between adjacent plungers can be shortened and space can be economized.

It will be noted that the fixing plate is a newly added member that is not present in conventional pumps, but the fixing plate does not require a complex design and can be easily manufactured by press molding using a press material, for example, and production costs also do not rise.

### (5) Plunger, Spring and Spring Seat

The plunger 25 shown in FIG. 2 is a rod-like member that has an outer shape that conforms to the small diameter space 23c in the barrel 23. Additionally, the plunger 25 is disposed with a collar portion 25a on its end portion on the opposite side of the fuel pressurization chamber 33 side; a spring seat 43 is locked to the collar portion 25a, and the spring 27 is nipped by and held between the spring seat 43 and the lower end of the barrel 23, whereby the plunger 25 is energized downward (in the opposite direction of the direction in which the plunger 25 pressurizes the fuel).

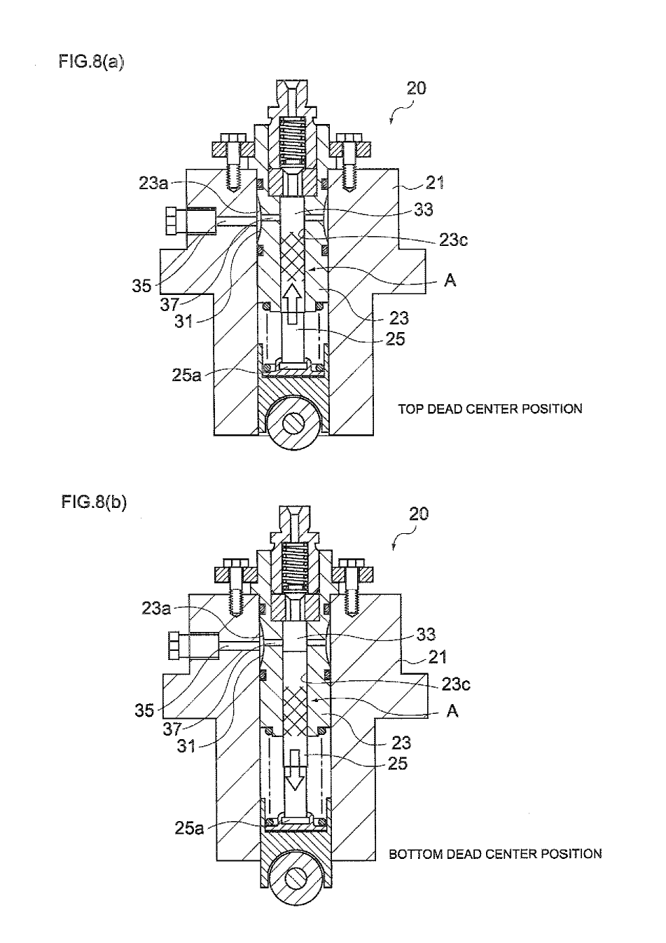

Further, plural grooves 25b (four in FIG. 2) are disposed in the outer periphery of the plunger 25 of the cassette type pump shown in FIG. 2, and fuel oil is interposed between the inner peripheral surface of the barrel 23 and the outer peripheral surface of the plunger 25, so that lubricity can be maintained. That is, in the cassette type pump 20 of the fuel injection system of the present invention, control of the flow rate and pressure-feed timing of the fuel is not performed but the fuel is fully pressure-fed to the common rail, so the length of the plunger 25 is designed to be relatively long in comparison to a conventional cassette type pump. As a result, as shown in FIGS. 8(a) and (b), even when the plunger 25 reciprocally moves between a top dead center (the position shown in FIG. 8(a)) and a bottom dead center (the position shown in FIG. 8(b)), a region A is formed where it is difficult for the fuel oil to move around part of the sliding surface of the plunger 25. Thus, by disposing the grooves 25b, the fuel oil can be retained inside the grooves 25b, the fuel oil can be delivered with respect to the region where it is difficult for lubricating oil to move around, and lubricity can be maintained. The number of the grooves 25b may be one or plural.

It will be noted that, as mentioned above, in the fuel injection system of the present embodiment, the pressure of the fuel is regulated by a pressure control valve; thus, in contrast to a conventional cassette type pump, a lead is not disposed in the plunger. Consequently, the fuel that been pressurized to a high pressure inside the fuel pressurization chamber is not returned to the low pressure side via a lead, so wear and damage to the plunger, the barrel and the housing resulting from the fuel pressure can be eliminated. Further, because it is not necessary to dispose a lead in the plunger, it is not necessary for the pump to be disposed with a rack mechanism for controlling the rotational position of the plunger, and it becomes unnecessary for the overall system to be disposed with a governor mechanism that actuates the rack mechanism. Consequently, the mechanical configuration of the cassette type pump or the overall system can be simplified, and mechanical strength and durability can be improved.

Here, the number of plungers disposed in the cassette type pump may be one or, as shown in FIG. 1, plural (two in FIG. 1). By disposing plural plungers, the flow rate of the fuel supplied to the common rail can be regulated in response the gear ratio between the crankshaft of the internal combustion engine and the camshaft and the number of rotations of the internal combustion engine. Further, in a condition where the gear ratio and the number of rotations are the same, the flow rate of the fuel can be increased as the number of plungers increases. Consequently, the fuel that is injected can be pressurized to an even higher pressure.

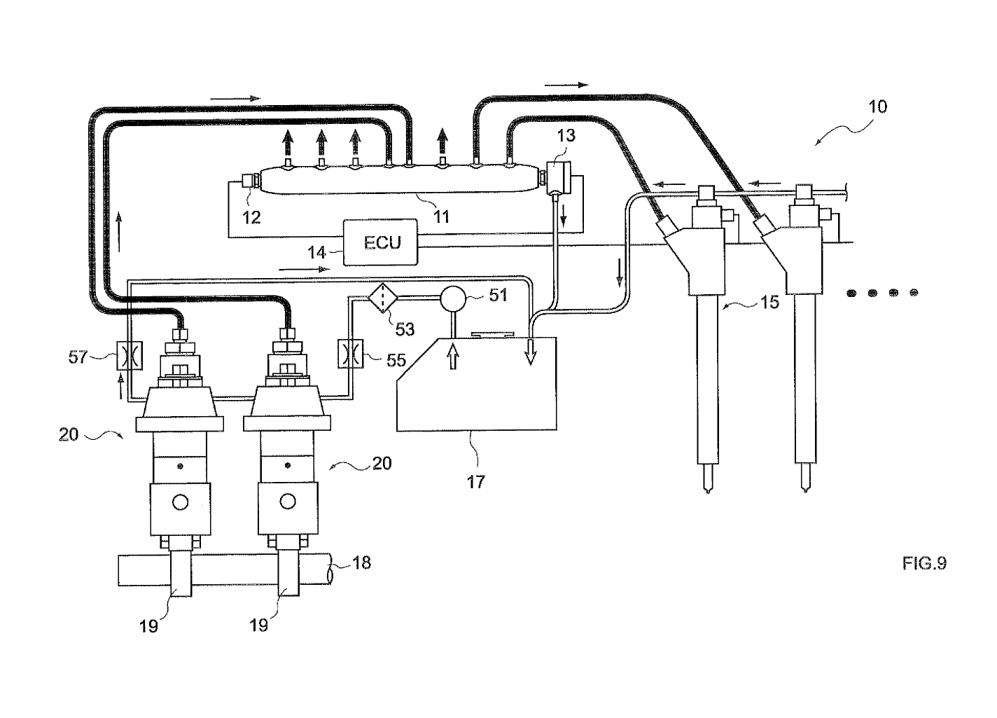

Further, when the number of plungers is plural, as shown in FIG. 1, the fuel injection system may have a configuration where one of the cassette type pump 20 is disposed with a plurality of the plungers as shown in FIG. 1 or a configuration where the fuel injection system is disposed with a plurality of the cassette type pumps 20 themselves as shown in FIG. 9. That is, because a cassette type pump is employed in a common rail system, the number of the plungers and cassette type pumps to be used can be freely selected in correspondence to the fuel flow rate, pressure and engine output.

Additionally, when the cassette type pump is disposed with a plurality of the plungers, even when the cam is rotated at a high speed in order to pressure-feed a large flow of high pressure fuel, as mentioned above, when the outer shape of the housing of the pump is made perfectly circular, stress acting on the housing can be dispersed and prevented from concentrating in one place. Consequently, the pump can stably pressure-feed a large flow of high pressure fuel.

### (6) Tappet

A tappet 45 shown in FIG. 2 is interposed between the cam 19 disposed in the internal combustion engine and the plunger 25 or the spring seat 43 disposed in the cassette type pump 20 and is a part for pushing up the plunger 25 in accompaniment with the up-and-down movement of the cam 19. The tappet 45 has an outer peripheral shape that conforms to the inner peripheral surface of the cylindrical space 21a in the housing 21 of the pump 20 and also has the function of centering the plunger 25 and the small diameter space 23c in the barrel 23. Further, the tappet 45 can also have a configuration that includes a tappet roller 47 in order to reduce wear resulting from contact with the cam 19.

In the fuel injection system of the present invention, the tappet can be connected to the plunger or the spring seat of the pump or can be disposed in the internal combustion engine. The fuel injection system may also have a configuration that does not use a tappet at all.

### 3. Common Rail (Pressure Accumulator)

As shown in FIG. 1, the common rail 11 is a part for accumulating the high pressure fuel that is pressure-fed from the cassette type pump 20 and supplying the high pressure fuel at an even pressure with respect to the plural injectors 15. A publicly known common rail can be appropriately used for the common rail.

Further, a pressure sensor 12 is attached to part of the common rail 11 and configured such that a detection signal is sent to the control means (ECU) 14 that controls the later-described pressure regulator 13.

Because of this common rail, high pressure fuel can be accumulated and the high pressure fuel can always be supplied with respect to the injectors, so it suffices for the cassette type pump to be given just the function of pressure-feeding the fuel, and the configuration of the pump can be remarkably simplified. Further, noise during operation of the internal combustion engine can be reduced because higher pressure fuel can be injected.

### 4. Pressure Regulator and Pressure Control Means

The pressure regulator 13 is configured using a publicly known electromagnetic valve (pressure control valve), for example, and the opening of the valve body is set on the basis of a signal sent from the control means (ECU) 14 in response to the pressure value detected by the aforementioned pressure sensor 12 disposed in the common rail 11. Additionally, some of the fuel that has been pressure-fed from the cassette type pump 20 is appropriately discharged, whereby the pressure inside the common rail is regulated to a desired value.

That is, the fuel injection system of the present invention is a system where the cassette type pump continues to pressure-feed high pressure fuel without controlling the flow rate, the injection timing and the pressure, the pressure regulator regulates the pressure inside the rail to a desired pressure value, the fuel injection system supplies the high pressure fuel to the injectors, and the injectors gauge the injection amount and the injection timing and inject, in order to supply, the fuel to the insides of the cylinders of the internal combustion engine.

By disposing the pressure regulator, it becomes unnecessary for the cassette type pump to control the pressure of the high pressure fuel that is pressure-fed and the fuel flow rate, and it suffices for the pump to simply continue pressure-feeding the fuel that has been pressurized to a high pressure. Consequently, in comparison to a conventional common rail system, complex electronic control by the pump can be omitted, regulation of the amount of fuel pressure-fed from the pump becomes possible by just the design of the cam and the plunger, and the configuration of the pump can be remarkably simplified.

Further, because the amount of fuel discharged from the pump can be controlled by changing the rotational speed of the cam and the design of the cam mountain, the cassette type pump can be universally used regardless of the specification of the internal combustion engine, and economical design and production become possible.

Moreover, because the fuel pressure can be freely regulated, the start-up performance of the fuel injection system when it is cold and the stability of the operating state of the fuel injection system can be improved.

In relation to the position where the pressure regulator is attached, it is not particularly limited as long as it is between the discharge valve of the pump and the fuel injectors; for example, the pressure regulator can be attached at a position on an end portion of the common rail. By attaching the pressure regulator to the body of the common rail, the common rail pressure can be directly changed.

It will be noted that excess fuel that is to be discharged is refluxed to the fuel tank via a fuel reflux path.

### 5. Fuel Injectors (Injectors) and Injection Control Means

The fuel injectors 15 are connected to the common rail 11 and are parts for injecting the high pressure fuel that is pressure-fed from the common rail 11 and supplying the fuel to the insides of the cylinders of the internal combustion engine. The mode of the injectors 15 is not particularly limited; for example, each of the injectors can have a configuration disposed with a nozzle body that includes a seat surface on which a needle valve body sits and an injection hole formed in the seat surface further downstream than the part of the seat surface that contacts the valve body, with the injector guiding, to the injection hole, fuel supplied from the upstream side of the seat surface when the needle valve body is lifted.

It will be noted that, although it is not illustrated, pressure amplifying means may be disposed such that the common rail is not made excessively large and such that a mechanical piston can be effectively pushed by the fuel having the common rail pressure at an arbitrary period.

The aforementioned injectors 15 can be electromagnetic valve type injectors that always energize the needle valve bodies towards the seat surfaces by springs or the like and open and close the needle valve bodies by switching between supplying electricity to and not supplying electricity to solenoids. In this case, the injection amount and the injection timing can be easily controlled by the control means (ECU) 14 for controlling the timing of the supply of electricity to the electromagnetic valves and the amount of time of the supply of electricity. More specifically, the fuel injection timing in the injectors of the internal combustion engine can be arbitrarily corresponded by a cam sensor, the injectors and control of the ECU. Consequently, noise during engine operation, and particulate matter and NO, (nitrogen oxide) included in the exhaust gas, can be reduced.

### 6. Inlet Orifice and Outlet Orifice

Further, in the fuel injection system 10 shown in FIG. 1, an inlet orifice 55 is disposed in the fuel supply path on the upstream side of the cassette type pump 20, and an outlet orifice 57 is disposed in the fuel reflux path by which the fuel is returned to the fuel tank 17 from the cassette type pump 20.

Of these, the inlet orifice 55 is used particularly in order to reduce the flow rate of the fuel flowing into the pump 20 when the number of rotations of the internal combustion engine has become large and to reduce unnecessary pressure-feeding of fuel to the common rail 11.

That is, industrial engines, which are the main target of the fuel injection system 10 of the present invention, are engines of which inexpensiveness is demanded and where the amount of fuel to be injected into the insides of the cylinders of the internal combustion engine is relatively low. For that reason, when a large flow of fuel is pressure-fed from the pump 20, the pressure is allowed to escape by the aforementioned pressure control valve 13, so the amount of fuel returned to the fuel tank 17 becomes greater and ends up leading to a drop in fuel efficiency. On the other hand, when throttle means such as an electromagnetically controlled variable throttle mechanism is used, the cost rises and control ends up becoming necessary regardless of the fuel flow rate.

Thus, in the fuel injection system 10 of the present embodiment, the inlet orifice 55 is used, whereby unnecessary pressure-feeding of fuel is reduced while controlling a rise in cost. That is, in fields where inexpensiveness is demanded as in fuel injection systems used in industrial engines, a balance can be achieved between costs and the function of the pump by using the inlet orifice 55. More specifically, until the amount of fuel pressure-fed from the pump 20 reaches a predetermined amount, there is no orifice throttle effect and the pump 20 can continue to pressure-feed without requiring particular control, and when the amount of fuel pressure-fed from the pump 20 exceeds the predetermined amount, the amount of fuel flowing into the pump 20 is reduced by the orifice throttle effect and a loss in fuel efficiency is controlled.

Further, the outlet orifice 57 is used in order to reduce the amount of fuel returned to the fuel tank 17 from the pump 20, maintain the pressure of the fuel flowing into the pump 20 at a higher pressure, and raise the pressure of the fuel that is pressure-fed to a higher pressure. That is, the fuel injection system 10 of the present invention does not require complex control by the pump 20, and the pump 20 is used in order to pressure-feed the fuel to the common rail 11, so by reducing the amount of fuel returned from the pump 20 and maintaining the pressure of the fuel flowing into the pump 20 high, greater fuel efficiency is achieved.

### 8. Operation of Fuel Injection System

The flow of fuel in the fuel injection system of the present embodiment that has been described above will be described below with reference to FIG. 1 and FIG. 2.

First, the fuel inside the fuel tank 17 is pumped up by a supply pump 51 via a prefilter (not shown) that traps foreign matter and is pressure-fed to the pressure introduction chamber 31 of the cassette type pump 20 via a main filter 53. At this time, when the amount of fuel pressure-fed by the supply pump 51 becomes relatively large, the fuel flow rate is reduced by the inlet orifice 55, and unnecessary pressure-feeding of fuel from the pump 20 is reduced.

The fuel that has been pressure-fed into the pressure introduction chamber 31 is sent to the inside of the fuel pressurization chamber 33 via the fuel passage 37 disposed in the barrel 23 of the pump 20. Then, the plunger 25 is pushed up in accompaniment with the rotation of the cam 19 disposed in the internal combustion engine, whereby the fuel passage 37 in the barrel 23 facing the fuel pressurization chamber 33 is closed, the fuel inside the fuel pressurization chamber 33 is pressurized to a high pressure, and the high pressure fuel is pressure-fed to the common rail 11 via the discharge valve 29. The high pressure fuel that has been pressure-fed is accumulated inside the common rail 11 and is supplied at an even pressure with respect to the injectors 15 in a state where the pressure of the fuel has been regulated by the pressure regulator 13. In this state, the injection holes in the injectors 15 are opened, whereby the high pressure fuel can be injected, so the high pressure fuel can be supplied to the insides of the cylinders of the internal combustion engine at a desired timing.

That is, in the cassette type pump, the work of pressurizing the fuel to a high pressure and discharging the high pressure fuel to the common rail is repeated, so the pressure inside the common rail can always be maintained in a high pressure state. Further, the common rail pressure that is maintained in a high pressure state can be relatively easily regulated to a desired pressure value by the pressure regulator and supplied to the injectors. Moreover, by controlling the injecting timing and the amount of injection time in the injectors, high-pressure and multiple-stage injection that could not be obtained in a conventional cassette type pump can be realized.

Further, because the configuration of the pump is simplified, the pump can exhibit excellent durability with respect to the pressure of the high pressure fuel and can stably inject the fuel.

### 9. Modifications

The fuel injection system for an internal combustion engine of the present invention is not limited to the embodiment that has been described up to now, and variations modifications thereof are possible.

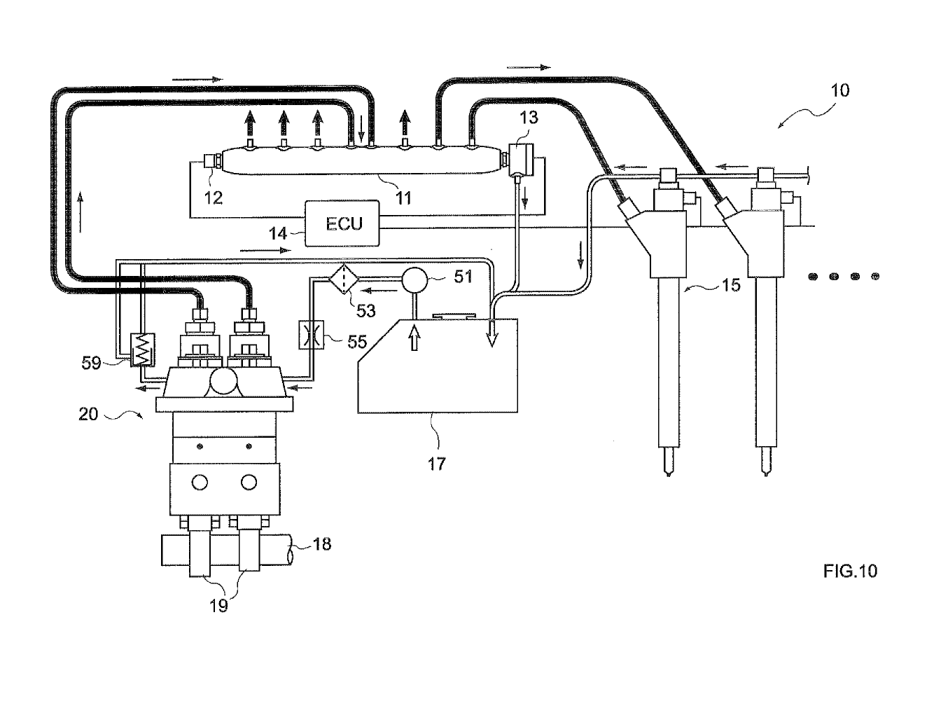

For example, in the example of FIG. 1, the outlet orifice 57 is disposed in the reflux path leading to the fuel tank 17 from the pump 20, but instead of this outlet orifice, as shown in FIG. 10, an overflow valve 59 can also be disposed. When the invention is configured in this manner, this becomes disadvantageous in terms of cost, but fuel is no longer returned to the fuel tank 17 until the pressure of the fuel flowing into the pump 20 exceeds a predetermined value, and when the pressure of the fuel flowing into the pump 20 exceeds the predetermined value, some fuel is quickly returned to the fuel tank 17, whereby the amount of fuel flowing into the pump 20 can be controlled and fuel efficiency can be made more efficient.

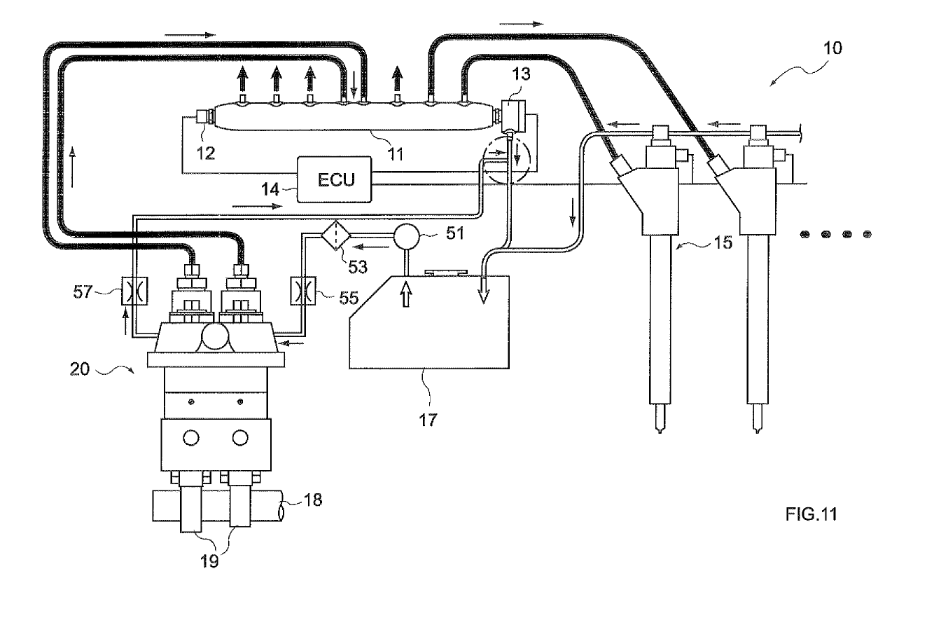

Further, as shown in FIG. 11, the reflux path leading to the fuel tank 17 from the pump 20 may also be caused to merge (the place enclosed by a circle in the drawing) with the reflux path leading to the fuel tank 17 from the pressure regulating valve 13. When the invention is configured in this manner, the fuel that is discharged from the pressure regulating valve 13 can be cooled when the fuel inside the common rail 11 reaches a high temperature, and the pressure regulating valve 13 can be prevented from sustaining damage due to heat.

According to the fuel injection system for an internal combustion engine of the present invention described above, the fuel injection system is used mainly in industrial engines and is disposed with the cassette type pump whose mechanical configuration is simplified, the common rail, the predetermined pressure regulator, and the pressure control means, whereby the fuel injection system can be made into one where the design and manufacture of the cassette type pump is simple and the overall system is simplified in comparison to a conventional common rail system. Consequently, mechanical strength and durability, which are demanded in the field of industrial engines, can be improved.

Further, because the fuel injection system is disposed with the common rail and the pressure regulator, regulation the flow rate and the pressure becomes unnecessary in the cassette type pump, and injection pressure control can be performed precisely. Consequently, the start-up performance of the fuel injection system when it is cold can be improved and noise during operation of the internal combustion engine can be reduced.

Speaking from the opposite standpoint, by employing a common rail in a fuel injection system using a cassette type pump that has conventionally come to be used mainly in industrial engines, fuel of an even higher pressure can be stably supplied with even better injection precision.

1-10. (canceled)

11. A fuel injection system for an internal combustion engine comprising:
a cassette type pump that is attachable to and detachable from an internal combustion engine disposed with a cam, the pump pressurizes fuel to a high pressure and pressure-feeds the high pressure fuel by a plunger that reciprocally moves in accompaniment with rotation of the cam;
a common rail that accumulates the high pressure fuel that is pressure-fed from the cassette type pump and supplies the high pressure fuel with respect to plural fuel injectors;
a pressure regulator that regulates the pressure inside the common rail; and
pressure control means that controls the pressure regulator on the basis of the pressure value inside the common rail.

12. The fuel injection system for an internal combustion engine of claim 1, wherein the fuel injectors are electromagnetic valves, and the fuel injection system further comprises injection control means that controls the fuel injection amount or the fuel injection timing of the electromagnetic valves.

13. The fuel injection system for an internal combustion engine of claim 11, wherein the fuel injection system is disposed with a plurality of the cassette type pump.

14. The fuel injection system for an internal combustion engine of claim 12, wherein the fuel injection system is disposed with a plurality of the cassette type pump.

15. The fuel injection system for an internal combustion engine of claim 11, further comprising an orifice in a fuel path on an upstream side of the cassette type pump.

16. The fuel injection system for an internal combustion engine of claim 11, wherein the cassette type pump includes a housing having a cylindrical space in which space both ends are open, a circular cylinder-shaped barrel inserted into the cylindrical space in the housing, a plunger held such that the plunger may freely reciprocally move inside the barrel which plunger pressurizing the fuel in response to the rotation of the cam, a spring which energizes the plunger in an opposite direction of a direction in which the plunger pressurizes the fuel, and a discharge valve for discharging the fuel that has been pressurized by the plunger, wherein an outer peripheral surface of the barrel is disposed with a flange portion, and the flange portion is nipped by and held between the housing and a fixing plate, whereby the barrel is fixed to the housing.

17. The fuel injection system for an internal combustion engine of claim 16, wherein the outer shape, of a section cut in a direction intersecting an axial direction of the cylindrical space, of a body portion of the housing inserted into the internal combustion engine is substantially perfectly circular.

18. The fuel injection system for an internal combustion engine of claim 16, wherein the flange portion has a circular shape that is concentric with the outer peripheral surface of the barrel.

19. The fuel injection system for an internal combustion engine of claim 17, wherein the flange portion has a circular shape that is concentric with the outer peripheral surface of the barrel.

20. The fuel injection system for an internal combustion engine of claim 16, wherein the planar shape of the fixing plate is rectangular or elliptical.

21. The fuel injection system for an internal combustion engine of claim 16, wherein the cassette type pump is disposed with a plurality of the barrel and the plunger.

22. The fuel injection system for an internal combustion engine of claim 11, wherein the fuel injection system is a fuel injection system that is used in any of construction machinery, agricultural machinery, small marine vessels and electrical generators.
